(19) United States
(12) Patent Application Publication
(10) Pub. No.: US 2008/0275704 A1
(43) Pub. Date: Nov. 6, 2008

(54) Method for a System of Performing a Dialogue Communication with a User

(75) Inventors: Thomas Portele, Bonn (DE); Holger Scholl, Herzogenrath (DE); Frank Sassenscheidt, Aachen (DE); Jens Friedemann Marschner, Wurselen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,052

(22) PCT Filed: Jul. 27, 2005
(86) PCT No.: PCT/IB2005/052522

§ 371 Date: Feb. 1, 2007

(30) Foreign Application Priority Data
Aug. 6, 2004 (EP) 04103811.8

(51) Int. Cl. G10L 15/18

(52) U.S. Cl. 704/257; 704/E15.001

(57) ABSTRACT

The present invention relates to a method for a system (101) of performing a dialogue communication with a user (105). The user's speech signal (107), which comprises a request of an action to be performed by the system (101), is recorded and analyzed. The result of the analyzing is compared with predefined semantic items (103) defined in the system (101), wherein an action is associated with each of the semantic items. Based on the comparison a candidate list (109), which identifies a limited number of semantic items (111, 113) selected from the predefined semantic items (103) is generated and presented to the user (105). An action associated with one the semantic item in the candidate list (109) is performed based on predefined criteria, unless the user (105) chooses a different semantic item from the candidate list (109).

The present invention relates to a method for a system of performing a dialogue communication with a user. By analyzing the user's speech signal, a candidate list of semantic items is generated and presented to the user. An action associated with one the semantic item in the candidate list is performed based on predefined criteria, unless the user chooses a different semantic item from the candidate list. The present invention further relates to a dialogue device to be used in a system for performing a dialogue communication with a user.

It is widely accepted within the community that speech recognition will never reach an accuracy of 100%. Therefore, methods to deal with errors and uncertainties are an important research field. The available methods are determined by the usage scenarios of the pertinent systems.

Voice-only dialogue systems like telephone-based systems mainly use clarification questions and implicit or explicit verification. Systems mainly intended for the dictation of arbitrary text into word processor, where a display shows the converted text, can supply alternatives derived from candidate lists delivered by a speech recognizer. During this a set of alternatives is generated, which is often represented as a tree graph, but can be converted to a list of possible word sequence. This is often called n-best candidate list. A dictation system can display the candidate list of words or part of a word sequence where the similarity between the different alternatives is sufficiently high and the user then can select the best alternative by keyboard command. These systems are however not adapted to communicate in an interactive way with a user.

For multimodal spoken dialogue systems, i.e. systems that are controlled by speech and an additional modality, the results of carrying out the user command are usually displayed in a form of a candidate list. For instance, an electronic program guide controlled by voice displays the best results regarding the query. For certain applications, which have a huge vocabulary, and a very simple dialogue structure, like entering destination for rout planning in car navigation system, the candidate list is displayed on a display. The problem with the prior art multimodal spoken dialogue systems is that the candidate list is the only possible reaction; and it is not possible to continue with the communication based on the candidate list. Due to this lack of an interactive communication between the user and the system the communication becomes very user unfriendly.

It is the object of the present invention to solve the above mentioned problems, by means of providing an interactive and user friendly method and a device for performing a dialogue communication with a user.

According to one aspect the present invention relates to a method for a system of performing a dialogue communication with a user, comprising the steps of:

recording a speech signal comprising a request of an action to be performed by said system, wherein said speech signal is generated by said user,

analyzing said recorded speech signal using speech recognition and comparing the result of said analyzing with predefined semantic items defined in the system, wherein an action is associated with each of said semantic items,

generating a candidate list based on said comparison, wherein said candidate list identifies a limited number of semantic items selected from said predefined semantic items,

presenting said candidate list to said user, and

performing an action associated with one of said semantic items in said candidate list, which action is to be chosen according to a predefined criteria, unless said user chooses a different semantic item from said candidate list.

Thereby, the candidate list provides a continuation of the interactive communication between the user and the system, which makes the communication very user friendly. Also, due to the limitation of the semantic items which the user can select from, the possibility of an error correction is enhanced greatly. As an example, if the user's request comprises to play a certain song and an exact match to this song is not found, a list of songs which match with the requested song, i.e. with similar pronunciation, up to a certain predefined level is displayed. In this case the user has the possibility to make a correction based on the displayed candidate list. This reduced the risk of an error is strongly, since the user' choice is solely based on the candidate list. In another example, the user's request may comprise to play something by the Rolling Stones. In this case the generated candidate list could comprise all the Rolling stones songs. The user could therefore select a song based on said candidate list, i.e. the Rolling Stones songs, or the system could select a song randomly if the user doesn't respond to the displayed candidate list.

In an embodiment said semantic items in said presented candidate list comprise various confidence levels based on different matches with the user's request.

Thereby, when representing the candidate list to the user the various actions associated with said semantic items can be presented to the user in a sorted way. As an example the first candidate is the one that has the best match with the user's request, the second candidate the second best match etc.

In an embodiment the semantic item from said candidate list with the highest confidence level is selected automatically, while said candidate list is presented to the user.

Thereby, the user needs only to select a semantic item in the case where the candidate with the highest confidence level was not the correct one. Therefore, the actual use of said candidate list is minimized, since it is relative likely that the semantic item with the highest confidence level is the correct one. As an example, the user can request a music jukebox to play a song. In this case, the possible candidate list comprises one or more songs with a similar pronunciation as the song requested (i.e. the user's speech signal). The song with the pronunciation which is closest to the requested song, i.e. the one with the best match, is therefore the alternative with the highest confidence level. Clearly, the communication is improved greatly if the user needs to perform a correction only in e.g. 10% cases.

In an embodiment the semantic item from said candidate list with the highest confidence level is selected automatically if the user does not select any semantic items in said candidate list.

Therefore, silence is the same as an approval. When the user sees or hears, depending on how the candidate list is presented, that the alternative with the highest confidence level is the correct one, he/she does not have to make any kind of a confirmation. Again, this minimizes the actual use of said candidate list.

In an embodiment said possible candidate list is presented to the user for a predefined time interval.

Thereby, it is not necessary to present the candidate list for a long time period for the user, and therefore the interaction between the system and the user becomes more continues. In the previous embodiment, where it was stated that a semantic item is selected automatically if the user does not respond, could e.g. comprise selecting it automatically after e.g. 5 seconds, i.e. the user has 5 second to select another semantic item.

In an embodiment presenting said candidate list to the user comprises displaying said candidate list for the user.

Thereby, one convenient alternative is provided to present the candidate list to the user. Preferably, it is automatically checked whether a display is present or not. If a display is present it may be used.

In an embodiment, presenting said possible candidate list to the user comprises playing said possible candidate list for the user.

Thereby, no display is needed to present the candidate list to the user. This can be a great advantage if the system comprises a car navigation system, where the user can interact with the system during driving.

In a further aspect, the present invention relates to a computer readable medium having stored therein instructions for causing a processing unit to execute said method.

According to another aspect the present invention relates to a dialogue device to be used in a system for performing a dialogue communication with a user, comprising:

a recorder for recording a speech signal comprising a request of an action to be performed by said system, wherein said speech signal is generated by said user,

a speech recognizer for analyzing said recorded speech signal using speech recognition and comparing the result of said analyzing with predefined semantic items defined in the system, wherein an action is associated with each of said semantic items, wherein based on said comparison a candidate list is generated, said candidate list identifying a limited number of semantic items selected from said predefined semantic items,

means for presenting said candidate list to said user, and

means for performing an action associated with one of said semantic items in said candidate list, which action is to be chosen according to a predefined criteria, unless said user chooses a different semantic item from said candidate list.

Thereby, a user friendly device which can be integrated into various systems is provided which improves a dialogue communication between said user and said system.

In an embodiment said means for presenting said candidate list to said user comprises a display.

The device is preferably adapted to check whether a display is present or not, and based thereon whether or not it should be displayed for the user. As an example, the display may be provided with a touch screen or the like so the user can, if necessary, perform a correction by pointing.

In an embodiment said means for presenting said candidate list to said user comprises an acoustic device.

Thereby, where e.g. a display is not present, the candidate list could be played loud for the user. Of course, the system could be provided with both display and acoustic device and the user could command the system to communicate in a dialogue way, e.g. because the user is driving, or via said display.

In the following the present invention, and in particular preferred embodiments thereof, will be described in more details in connection with accompanying drawings in which

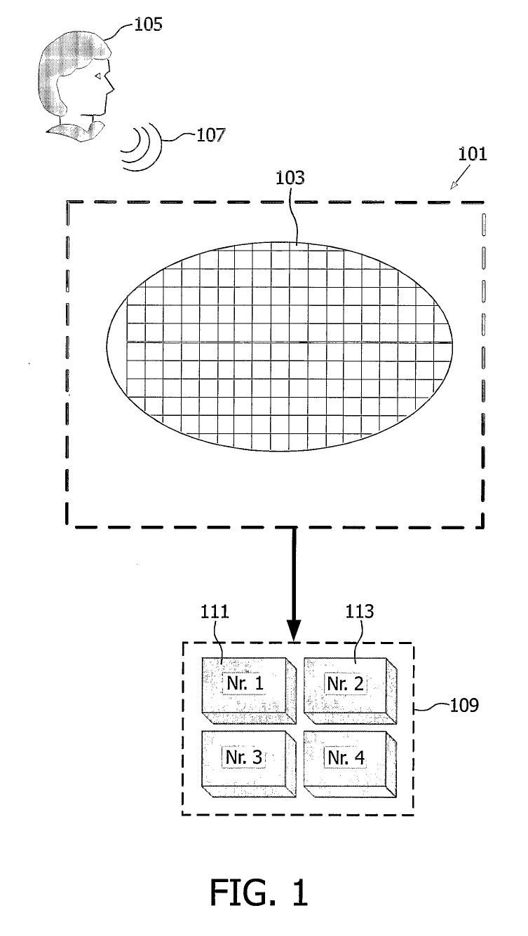

FIG. 1 illustrates graphically a dialogue communication between a user and a system according to the present invention,

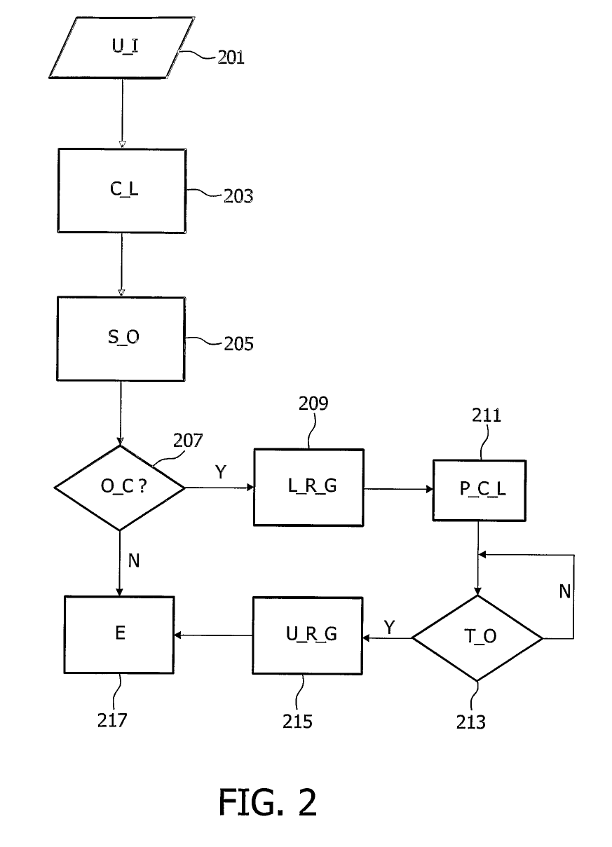

FIG. 2 illustrates a flow chart of an embodiment of a method for a system of performing a dialogue communication with a user,

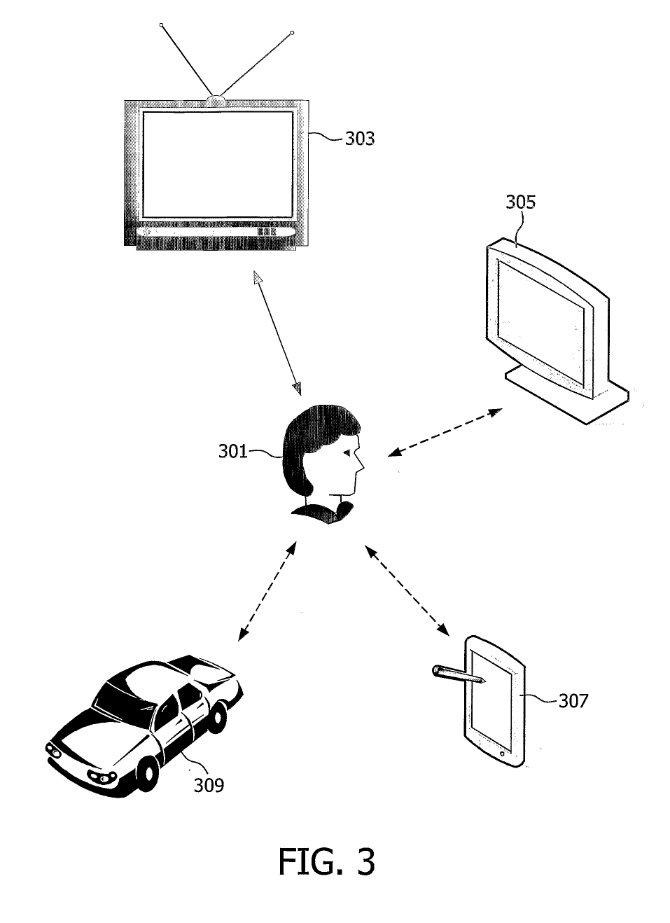

FIG. 3 shows examples of systems comprising a dialogue device for performing a dialogue communication with a user, and

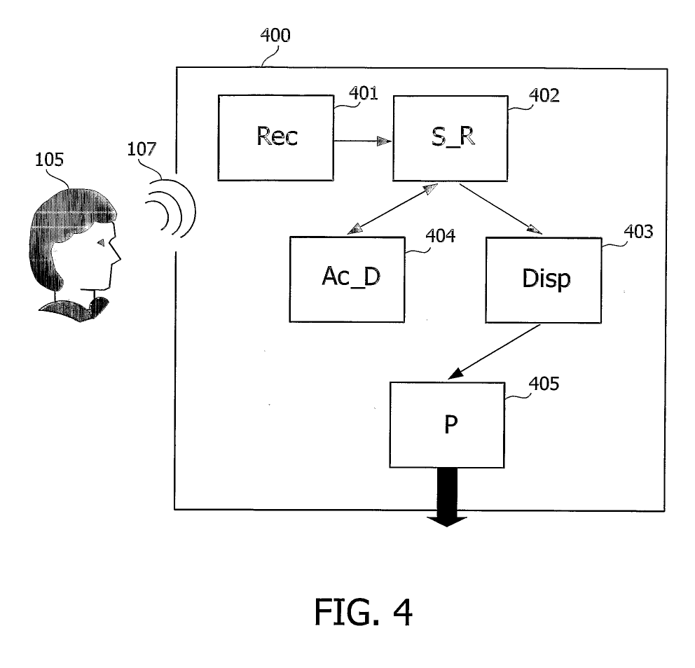

FIG. 4 shows a dialogue device according to the present invention to be used in a system for performing a dialogue communication with a user.

FIG. 1 illustrates graphically a dialogue communication between a user 105 and a system 101 according to the present invention. A speech signal 107 comprising a request of an action to be performed by said system 101 is generated by the user and recorded by the system 101. By using speech recognition the speech signal is analyzed and the result of the analyses is compared with predefined semantic items 103 defined in the system 101. These semantic items can be actions to be performed by the system, e.g. different songs to be played if the system 101 is a music jukebox. The analyses may comprise finding matches between the pronunciation in the user's request and the predefined semantic items 103. Bases on the analysis a candidate list 109, is generated comprising a limited number of semantic items, e.g. 111, 113, which fulfill a matching criterion with predefined semantic items 103. As an example, the matching criterion could comprise all matches which are more than 80% likely to be the correct match, are to be considered as likely candidates. This candidate list 109 is presented to the user 105, and an action associated with one of the semantic items 111, 113, in the candidate list is performed, based on a predefined criterion, unless the user 105 chooses a different semantic item from said candidate list. The predefined criterion could as an example comprise the selecting automatically the action associated with the semantic item having the best match, i.e. the one having the highest confidence level.

FIG. 2 illustrates a flow chart of an embodiment of a method for a system of performing a dialogue communication with a user. In this embodiment the user's speech signal or the user's input (U_I) 201 comprising a request of an action to be performed by said system is processed by a speech recognizer, which generates one or more alternatives or a candidate list (C_L) 203 based on the best match to a predefined semantic item in the system. The user's speech signal could as an example comprise a request for a music jukebox to play a song “wish you were here” by Pink Floyd. Based on the user's speech signal (U_I) 201 the system constructs a candidate list ordered in accordance to the best match to the predefined semantic items in the system and starts the desired operation with the best candidate (S_O) 205 automatically, i.e. plays the candidate best matching the title “wish you were here”. If the candidate list comprises only this one candidate (O_C?) 207 the normal operation of the system would be continued, e.g. in the case the device is a music jukebox the normal display is proceeded (E) 217.

If the candidate list comprises more than one candidate (O_C?) 207 a candidate list is represented (P_C_L) 111 for the user by e.g. loading a recognition grammar with the candidate entries (L_R_G) 209. The candidate list could e.g. comprise a list of artists with a similar pronunciation. The candidate list may be displayed for some predefined time period, so the user has an opportunity to select another candidate entry and thereby perform a correction. If the user does however not respond after a predefined time period (T_O) 213 it is assumed that the candidate with the best match is correct, e.g. the candidate listed nr. 1. In both cases the recognition grammar with the candidate entries is unloaded (U_R_G) 215 and the normal display is proceeded (E) 217.

In one embodiment, if in an operation to be formed, e.g. to play a song, one candidate has a very high confidence level the request is initiated immediately, i.e. the song is played, without representing a list of possible candidates having much lower confidence level. If the song is however not correct the user could state that by e.g. repeat the title again. This would preferably be responded by the device by representing a possible candidate list to the user.

In one embodiment, the candidate list is represented, although only one reasonable alternative is contained in the candidate list. This is to supply feedback about the device's interpretation about the user's input. As an example if the device is integrated in a jukebox, the name of the song is displayed while the song is being played.

In one embodiment the device is adapted to display addressable items for the user. As an example where the user's input is to play something by the Rolling Stones, the candidate list comprises all (or part) of the Rolling Stones songs.

In one embodiment the user selects a candidate entry by speaking the name of an alternative candidate, or by naming the desired alternative either directly or by its position in the list (e.g. “number two”). In the latter case the speech recognizer may be robust for number.

In one embodiment the user selects a candidate entry by using a pointing modality, e.g. touch screen, remote control or the like.

In one embodiment the best candidate may be excluded from the recognition vocabulary as the user will not use it for correction, and it cannot be mistaken for other candidates. As an example, the user says: “play something with the Beatles” and the device understands this user input as “play something with the Eagles”. When the user notices the mistake and repeats “play something with the Beatles” the device excludes the Eagles, since it was not correct in the first time. Thereby, the choice for possible candidates is reduced by one candidate, i.e. the Eagles.

In one embodiment the device conveys to the user, which addressable items are known. As an example, in a music jukebox application, the correct name of a song is not known by the user, e.g. the user says: “Sergeant Peppers” while the data base contains “Sergeant Pepper's lonely hearts”. The device would thereby either suggest this one candidate to the user, or it starts immediately to play this song.

FIG. 3 shows examples of systems comprising a dialogue device for performing a dialogue communication with a user. The user 301 could interact with TV 303 having dialogue device. When the device senses the presence of a monitor it may automatically use the monitor to interact with the user 301, whereby a candidate list may be activated and displayed on the TV monitor and deactivated after some time, e.g. 5 seconds. Of course the interaction could also be via dialogue. By default the TV 303 is as an example turned off during interaction between the user 301 and the dialogue device. Also, if the user 301 encounters a problems during the interaction, e.g. because the level of environmental noise is suddenly increased, or a new application within the system is used for the first time, the user 301 can switch on the TV 303 and can get feedback on what the device understood as well as the possibility to select the intended alternative.

The dialogue device could also be integrated into a computer or a “Home Dialogue system” 305 or similar systems which are adapted to interact with the user 301 in a human-like way. In this example, additional sensors, e.g. cameras, are further used as an interactive agent. Also, the dialogue device could be integrated into any kind of mobile devices 307, a touch pad and the like. Another example of an application of using the device is a car navigation system 309. In all theses cases the dialogue device is adapted to sense the way of interacting with the user, i.e. via dialogue or monologue.

FIG. 4 shows a dialogue device 400 according to the present invention to be used in a system 101 for performing a dialogue communication with a user 105, wherein the dialogue device 400 comprises a recorder (Rec) 401, a speech recognizer (S_R) 402, a display device (Disp) 403 and/or an acoustic device (Ac_D) 404 and a processor (P) 405.

The recorder (Rec) 401 records the speech signal 107 from the user 105, wherein the speech signal 107 can e.g. comprise a request for a music jukebox to play a song. The speech recognizer (S_R) 402 then analyzes the recorded speech signal 107 using speech recognition and compares the result from the analyzing with predefined semantic items 103 defined and/or pre-stored in the system 101. If the result of the analyzing comprises a number of alternatives of possible candidates a candidate list is generated based on the best match to the predefined semantic item 103 in the system 101. The display device (Disp) 403 and/or the acoustic device (Ac_D) 404 then present the candidate list 109 to said user 105. This can e.g. be done by displaying the candidate list on a TV monitor, or by playing it for the user. This is typically the case if the candidate list comprises more than one candidate.

The processor (P) 405 can e.g. be preprogrammmed so that it selects automatically after a pre-defined time the candidate with the best match, e.g. the candidate listed nr. 1 is to be played. Also, in cases where the candidate list comprises only a one candidate the normal operation of the system is continued, e.g. in the case the device is a music jukebox the candidate is played automatically.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for a system of performing a dialogue communication with a user, comprising:
recording a speech signal that includes a request of an action to be performed by said system, wherein said speech signal is generated by said user,
analyzing said recorded speech signal using speech recognition and comparing the result of said analyzing with predefined semantic items defined in the system, wherein an action is associated with each of said semantic items,
generating a candidate list based on said comparison, wherein said candidate list identifies a limited number of semantic items selected from said predefined semantic items,
presenting said candidate list to said user, and
performing an action associated with one of said semantic items in said candidate list, which action is to be chosen according to one or more predefined criteria, unless said user chooses a different semantic item from said candidate list.

2. The method of claim 1, wherein said semantic items are ordered within said presented candidate list according to their respective confidence levels based on calculated likelihood of matching with the user's request.

3. The method of claim 1, wherein the semantic item from said candidate list with the highest confidence level is selected automatically, while said candidate list is presented to the users.

4. The method of claim 1, wherein the semantic item from said candidate list with the highest confidence level is selected automatically if the user does not select any semantic items in said candidate list.

5. The method of claim 1, wherein said candidate list is presented to the user for a predefined time interval.

6. The method of claim 1, wherein presenting said candidate list to the user comprises displaying said candidate list for the user.

7. The method of claim 1, wherein presenting said candidate list to the user comprises playing said candidate list for the user.

8. A computer readable medium having stored therein instructions for causing a processing unit to execute the method of claim 1.

9. A dialogue device for use in a system for performing a dialogue communication with a user, comprising:
a recorder for recording a speech signal comprising a request of an action to be performed by said system, wherein said speech signal is generated by said user,
a speech recognizer for analyzing said recorded speech signal using speech recognition and comparing the result of said analyzing with predefined semantic items defined in the system, wherein an action is associated with each of said semantic items, wherein based on said comparison a candidate list is generated, said candidate list identifying a limited number of semantic items selected from said predefined semantic items,
means for presenting said candidate list to said user, and
means for performing an action associated with one of said semantic items in said candidate list, which action is to be chosen according to a predefined criteria, unless said user chooses a different semantic item from said candidate list.

10. The dialogue device of claim 9, wherein said means for presenting said candidate list to said user comprises a display.

11. The dialogue device of claim 9, wherein said means for presenting said candidate list to said user comprises an acoustic device.
